(19) United States
(12) Patent Application Publication
(10) Pub. No.: US 2025/0283488 A1
(43) Pub. Date: Sep. 11, 2025

(54) METHOD FOR CHECKING THE STATE OF A HYDRAULIC ACCUMULATOR

(71) Applicant: Deere & Company, Moline, IL (US)

(72) Inventors: STEFAN BROCKE, MANNHEIM (DE); NORBERT FRITZ, ILVESHEIM (DE)

(21) Appl. No.: 19/050,182

(22) Filed: Feb. 11, 2025

(30) Foreign Application Priority Data
Mar. 6, 2024 (EP) 24161858.6

(51) Int. Cl. F15B 19/00; B60T 13/14; B60T 13/68; B60T 17/22; B62D 5/30; F15B 1/04; F15B 1/26; F15B 15/10; G07C 5/08

(52) U.S. Cl. CPC F15B 19/005; B60T 13/148; B60T 17/22; B62D 5/30; F15B 1/04; F15B 1/26; F15B 15/10; G07C 5/0808; B60T 13/686; B60T 2270/402

(57) ABSTRACT

In a method for checking the state of a hydraulic accumulator having a fluid chamber for the reversible storage of hydraulic energy, an evaluation of a charging procedure of the hydraulic accumulator occurs by filling the fluid chamber with pressurized hydraulic fluid to check whether a specified minimum charge energy is reached or whether a specified charge pressure curve for in-spec operation of the hydraulic accumulator is maintained, in order to conclude a malfunction of the hydraulic accumulator if deviations occur in this regard.

### CROSS-REFERENCE TO RELATED APPLICATIONS

This application claims priority to European Patent Application No. 24161858.6, filed Mar. 6, 2024, which is hereby incorporated by reference.

### FIELD OF THE DISCLOSURE

The disclosure relates to a method for checking the state of a hydraulic accumulator.

### BACKGROUND

A hydraulic accumulator stores pressurized hydraulic fluid for a hydraulic system.

### SUMMARY

In work vehicles, for example agricultural and forestry vehicles, hydraulic accumulators of this type serve, inter alia, for the redundant backup of the hydraulic supply for critical hydraulic functions, for example functions of a hydraulic brake system or hydrostatic vehicle steering, for example in the event of a functional impairment of a high pressure pump provided for the hydraulic supply, which is generally a pivotable pump fed from a hydraulic reservoir. Hydraulic accumulators are known in various forms; however, they essentially have a fluid chamber, which can be compressively preloaded in opposition to the effect of a compression means and which serves for the reversible storage of hydraulic energy. In this regard, the hydraulic accumulator may be designed as a diaphragm accumulator, in which the compression means is formed by an elastic diaphragm made of metal or an elastomer, which can be deflected in opposition to the resetting effect of a compressible gas, generally nitrogen, during the filling of the fluid chamber. Instead of a diaphragm accumulator, this may also be a bladder accumulator or a piston accumulator. In the latter case, the compression means may be formed by a mechanically spring-preloaded pressure piston.

If the hydraulic accumulator is used for the redundant backup of the hydraulic supply for critical hydraulic functions, it is subject to more stringent requirements in terms of its failure-safety. This may be adversely affected in the event of a loss of function of the compression means due to a defect (e.g., owing to the compressible gas escaping due to a leak or owing to a defect of a coil spring provided to generate the mechanical spring preload).

Therefore, the object of the present disclosure is to specify a method for checking the state of a hydraulic accumulator, by means of which a degradation of the energy storage capacity of the hydraulic accumulator can be detected promptly and reliably.

This object is achieved by a method for checking the state of a hydraulic accumulator having the features of one or more of the embodiments disclosed herein.

In the method according to the disclosure for checking the state of a hydraulic accumulator, the hydraulic accumulator has a fluid chamber, which can be compressively preloaded in opposition to the resetting effect of a compression means, for the reversible storage of hydraulic energy, it being provided that the fluid chamber, during a charging procedure of the hydraulic accumulator when prompted by a control unit,
(i) is filled with pressurized hydraulic fluid until a specified target charge pressure p_target is reached, the charge energy E_a used during filling being calculated by the control unit through time integration of the product of the sensor-recorded charge pressure p_a and the charge volume flow V_flow and compared to a specified minimum charge energy min_E_a in order to conclude a malfunction of the hydraulic accumulator if the specified minimum charge energy min_E_a is not reached, and/or
(ii) is filled with pressurized hydraulic fluid for a specified fill time interval [t1, t2], a resultant pressure difference delta p_a in the fluid chamber relative to a supplied charge volume delta V_a being recorded by a sensor and checked by the control unit for conformity with a specified charge pressure curve p_a(V_a) for in-spec operation of the hydraulic accumulator in order to conclude a malfunction of the hydraulic accumulator in the event of a lack of conformity.

The charging procedure can take place with the start-up of an agricultural or forestry vehicle equipped with the hydraulic accumulator, each of the two approaches (i) and (ii) enabling a degradation of the energy storage capacity of the hydraulic accumulator to be detected promptly and reliably in different ways.

The hydraulic accumulator may be a diaphragm accumulator, in which the compression means is formed by an elastic diaphragm made of metal or an elastomer, which can be deflected in opposition to the resetting effect of a compressible gas, generally nitrogen, during the filling of the fluid chamber. However, it should be noted that the hydraulic accumulator may be of any design; in this regard, a bladder accumulator or a piston accumulator are equally possible. The construction thereof is well known, so further statements are unnecessary at this point.

The control unit detects whether the specified target charge pressure p_target is reached in the case of the first approach (i) by monitoring the charge pressure p_a recorded by a pressure sensor communicating with the fluid chamber of the hydraulic accumulator. The charge energy E_a used during filling is given as

$$E\_a = {\int }_{t 1}^{t 2} p\_a * V\_flow * dt ,$$

with time integration being carried out over the fill time interval [t1, t2].

In the case of the second approach (ii), however, the control unit carries out an evaluation as to whether the ascertained value pair (delta p_a, delta V_a) can be placed within a permissible tolerance range Δp_a(V_a) along the specified charge pressure curve p_a(V_a). If this is the case, it is to be assumed that the hydraulic accumulator is functioning properly. The supplied charge volume delta V_a results from the duration of the fill time t2-t1 for a charge volume flow V_flow which is understood to be known and is assumed to be constant at a given operating temperature of the hydraulic fluid.

The specified minimum charge energy min_E_a or the specified charge pressure curve p_a(V_a) is different depending on the hydraulic accumulator used and is ultimately determined by the respective specifications of the manufacturer.

Advantageous developments of the method according to the disclosure can be found in one or more of the embodiments disclosed herein.

The pressurized hydraulic fluid can be generated by a pivotable pump fed from a hydraulic reservoir. The pivotable pump may be part of a hydraulic system arranged in an agricultural or forestry vehicle and may serve for the hydraulic supply to a multiplicity of hydraulic consumers. The pivotable pump is typically set in rotation via a gear drive by means of an internal combustion engine comprised by the vehicle; however, it may also be associated with a separate drive in the form of an electric motor.

The option arises here for the charge volume flow V_flow to be calculated by the control unit, starting with a sensor-recorded pump speed N1 subject to a displacement volume flow V1 of the pivotable pump per revolution resulting from a sensor-recorded pivot angle β,

$$V\_flow = N 1 * V 1 ,$$

with this taking place under the assumption that volume flow components which decrease in the direction of the hydraulic consumers are known or are insignificantly small.

The sensor which serves to record the pump speed N1 or the pivot angle β is a speed sensor or pivot-angle sensor which communicates with the control unit.

On the other hand, it is also conceivable that the charge volume flow V_flow is calculated by the control unit subject to a sensor-recorded pressure decrease p_a-p_p, which occurs at a hydraulic diaphragm through which the pressurized hydraulic fluid flows during the filling of the fluid chamber. If a pivotable pump is provided for the primary hydraulic supply, the hydraulic diaphragm is acted upon by the delivery pressure p_p of the pivotable pump at the inlet side, whereas the charge pressure p_a in the fluid chamber of the hydraulic accumulator is applied at the outlet side,

$$V\_flow = ( p\_p - p\_a ) * k ,$$

where k is a characteristic constant for the hydraulic diaphragm in question, where k is a characteristic constant for the hydraulic diaphragm 54 in question, which depends, amongst other things, on the operating temperature of the hydraulic fluid passing through it. The delivery pressure p_p is recorded by a further pressure sensor which communicates with a delivery outlet of the pivotable pump.

If the hydraulic accumulator is comprised by a hydraulic system of an agricultural or forestry vehicle, it may be provided that the control unit prevents the start-up of the vehicle in the event of a detected malfunction of the hydraulic accumulator by intervening in a drive management system or, if need be, it permits start-up with a reduced driving speed. This primarily takes into account circumstances in which the hydraulic accumulator serves for the redundant backup of the hydraulic supply for critical hydraulic functions, such as functions of a hydraulic brake system or hydrostatic vehicle steering.

With the completion of the charging procedure, the hydraulic fluid supplied to the hydraulic accumulator may be enclosed in the fluid chamber as a result of closing a valve device. To this end, the valve device comprises, for example, a 2/2-way valve, which can be actuated electrically by the control unit, or a non-return valve.

In addition, the hydraulic pressure of the stored hydraulic fluid may be monitored by the control unit with regard to maintaining a specified minimum system pressure min_p_a, in order to set the agricultural or forestry vehicle to emergency operating mode in the event that the specified minimum system pressure min_p_a is not reached. The emergency operating mode may provide for the driving speed of the vehicle to be limited for the purpose of realizing a slow speed, which enables a safe journey back to a depot or to a workshop, or it may provide for a complete vehicle stop. The hydraulic pressure of the stored hydraulic fluid is generally identical to the sensor-recorded charge pressure p_a or it may be derived from this.

In the event of a detected functional impairment or failure of the primary hydraulic supply of the agricultural or forestry vehicle, the option arises of using the stored hydraulic fluid to operate selected hydraulic consumers of the vehicle, for example a hydraulic brake system and/or hydrostatic vehicle steering, by opening the valve device or an electrically actuable 2/2-way valve comprised thereby. In this way, the maneuverability of the vehicle is maintained, at least for a certain time period, so that the driver has the option of bringing the vehicle safely to a standstill at a suitable point.

In addition, upon detection of a malfunction of the hydraulic accumulator or in the event of a functional impairment or failure of the primary hydraulic supply of the vehicle, the output of suitable driver information may take place via a user interface which is in communication with the control unit. This also applies in the event that the emergency operating mode is triggered.

The above and other features will become apparent from the following detailed description and accompanying drawings.

### BRIEF DESCRIPTION OF THE DRAWINGS

The method according to the disclosure will be explained in more detail hereinafter on the basis of the appended drawings, in which:

FIG. 1 shows a schematically illustrated arrangement for carrying out the method according to the disclosure for checking the state of a hydraulic accumulator in an agricultural tractor;

FIG. 2 shows an operating state of the arrangement according to FIG. 1 whilst carrying out a charging procedure of the hydraulic accumulator;

FIG. 3a shows an illustration of the charging procedure for the event that a specified minimum charge energy min_E a is reached;

FIG. 3b shows an illustration of the charging procedure for the event that a specified minimum charge energy min_E a is not reached;

FIG. 4a shows a specified fill time interval [t1, t2] for carrying out the charging procedure;

FIG. 4b shows a specified charge pressure curve p_a(V_a) for in-spec operation of the hydraulic accumulator;

FIG. 5 shows an operating state of the arrangement according to FIG. 1 on completion of the charging procedure;

FIG. 6 shows an operating state of the arrangement according to FIG. 1 in the event of a detected functional impairment or failure of the primary hydraulic supply of the agricultural tractor; and

FIG. 7 shows a modification to the arrangement illustrated in FIG. 1 for carrying out the method according to the disclosure.

### DETAILED DESCRIPTION

The embodiments or implementations disclosed in the above drawings and the following detailed description are not intended to be exhaustive or to limit the present disclosure to these embodiments or implementations.

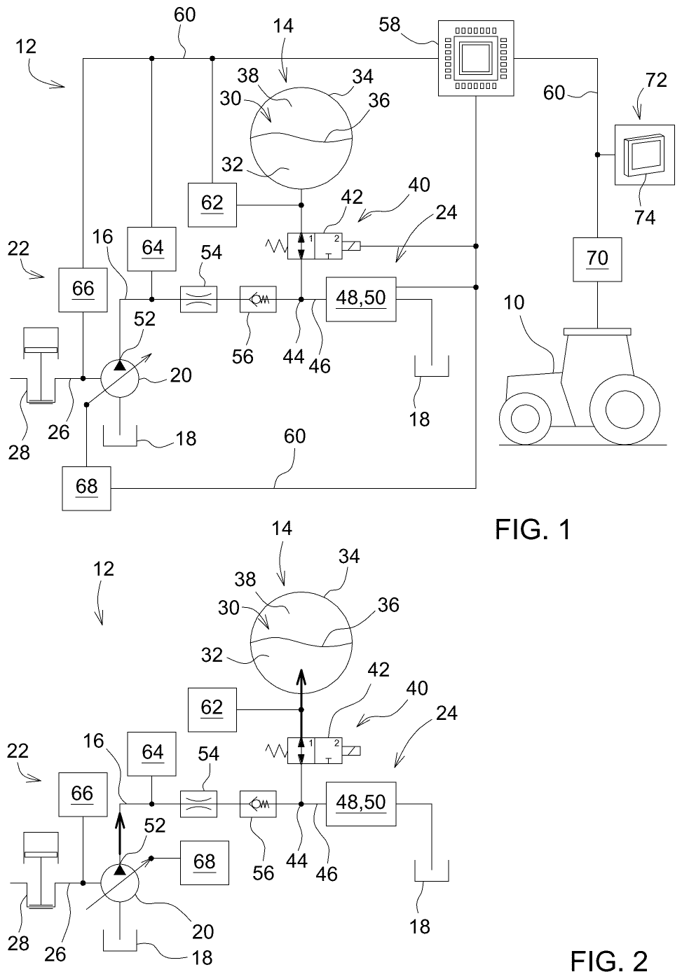

FIG. 1 shows a schematically illustrated arrangement, on the basis of which the functionality of the method according to the disclosure for checking the state of the hydraulic accumulator shall be illustrated.

The arrangement 12, which is found in an agricultural tractor 10, comprises a hydraulic accumulator 14 which may be acted upon by pressurized hydraulic fluid via a supply line 16, which pressurized fluid is generated by a pivotable pump 20 fed from a hydraulic reservoir 18. The pivotable pump 20 is part of a hydraulic system 22 arranged in the agricultural tractor 10 and serves for the hydraulic supply of a multiplicity of hydraulic consumers 24. To this end, the pivotable pump 20 is set in rotation via a gear drive 26 by means of an internal combustion engine 28 comprised by the agricultural tractor 10.

The hydraulic accumulator 14 has a fluid chamber 32, which can be compressively preloaded in opposition to the effect of a compression means 32 and which serves for the reversible storage of hydraulic energy. By way of example, the hydraulic accumulator 14 may be designed as a diaphragm accumulator 34, in which the compression means 30 is formed by an elastic diaphragm 36 made of metal or an elastomer, which can be deflected in opposition to the resetting effect of a compressible gas 38, in this case nitrogen, during the filling of the fluid chamber 32. Instead of a diaphragm accumulator 34, however, this may also be a bladder accumulator or a piston accumulator.

Via a T-junction 44, a valve device 40 in the form of a 2/2-way valve 42, which is connected to the fluid chamber 32, communicates, on the one hand, with the supply line 16 coming from the pivotable pump 20 and, on the other, with a feed line 46 for supplying selected hydraulic consumers 24, in this case a hydraulic brake system 48 and/or hydrostatic vehicle steering 50. A hydraulic diaphragm 54 is located in the supply line 16 between a delivery outlet 52 of the pivotable pump 20 and the T-junction 44, followed by a non-return valve 56 which permits a flow in the filling direction of the hydraulic accumulator 14. The 2/2-way valve can be electrically actuated by a control unit 58 (e.g., a controller including a processor and memory) via a CAN data bus 60.

As can likewise be seen in FIG. 1, a pressure sensor 62 for recording a charge pressure p_a in the fluid chamber 32 of the hydraulic accumulator 14, a further pressure sensor 64 for recording a delivery pressure p_p at the delivery outlet 52 of the pivotable pump 20 and, furthermore, a speed sensor 66 or pivot angle sensor 68 for recording a pump speed N1 or a pivot angle β of the pivotable pump 20 by means of a sensor are present. The corresponding sensor data are communicated to the control unit 58 via the CAN data bus 60.

Furthermore, it is possible for the control unit 58 to intervene in a drive management system 70 of the agricultural tractor 10 via the CAN data bus 60. A user interface 72 moreover enables driver information to be output via an associated display 74.

FIG. 2 shows an operating state of the arrangement 12 whilst carrying out a charging procedure of the hydraulic accumulator 14. The filling of the still empty, or possibly previously deliberately emptied, hydraulic accumulator 14 takes place upon start-up of the agricultural tractor 10, i.e., when starting the internal combustion engine 28.

The monitoring of the state of the hydraulic accumulator 14 takes place during the charging procedure, this being characterized by two different approaches.

### (i) Analyzing the Charge Energy

A first approach provides that, at a prompt from the control unit 58, the hydraulic accumulator 14 is filled with pressurized hydraulic fluid from the pivotable pump 20 by opening the 2/2-way valve 42 until a specified target charge pressure p_target is reached, the charge energy E_a used during filling being calculated by the control unit 58 through time integration of the product of the sensor-recorded charge pressure p_a and the charge volume flow V_flow and compared to a specified minimum charge energy min_E_a in order to conclude a malfunction of the hydraulic accumulator 14 if the specified minimum charge energy min_E_a is not reached.

The charge volume flow V_flow is calculated by the control unit 58, either starting with the sensor-recorded pump speed N1 subject to the displacement volume flow V1 of the pivotable pump 20 per revolution resulting from a sensor-recorded pivot angle β,

$$V\_flow = N 1 * V 1 ,$$

with this taking place under the assumption that volume flow components which decrease in the direction of the hydraulic consumers 24 are known or are insignificantly small. Alternatively, the charge volume flow V_flow is calculated by the control unit subject to a sensor-recorded pressure decrease p_a-p_p, which occurs at a hydraulic diaphragm 54 through which the pressurized hydraulic fluid flows during the filling of the fluid chamber 32. The hydraulic diaphragm 54 is acted upon by the delivery pressure p_p of the pivotable pump 20 at the inlet side, whereas the charge pressure p_a in the fluid chamber 32 of the hydraulic accumulator 14 is applied at the outlet side,

$$V\_flow = ( p\_p - p\_a ) * k ,$$

where k is a characteristic constant for the hydraulic diaphragm 54 in question, which depends, amongst other things, on the operating temperature of the hydraulic fluid passing through it.

The control unit 58 detects whether the specified target charge pressure p_target has been reached by monitoring the sensor-recorded charge pressure p_a. The charge energy E_a used during filling is given as

$$E\_a = {\int }_{t 1}^{t 2} p\_a * V\_flow * dt ,$$

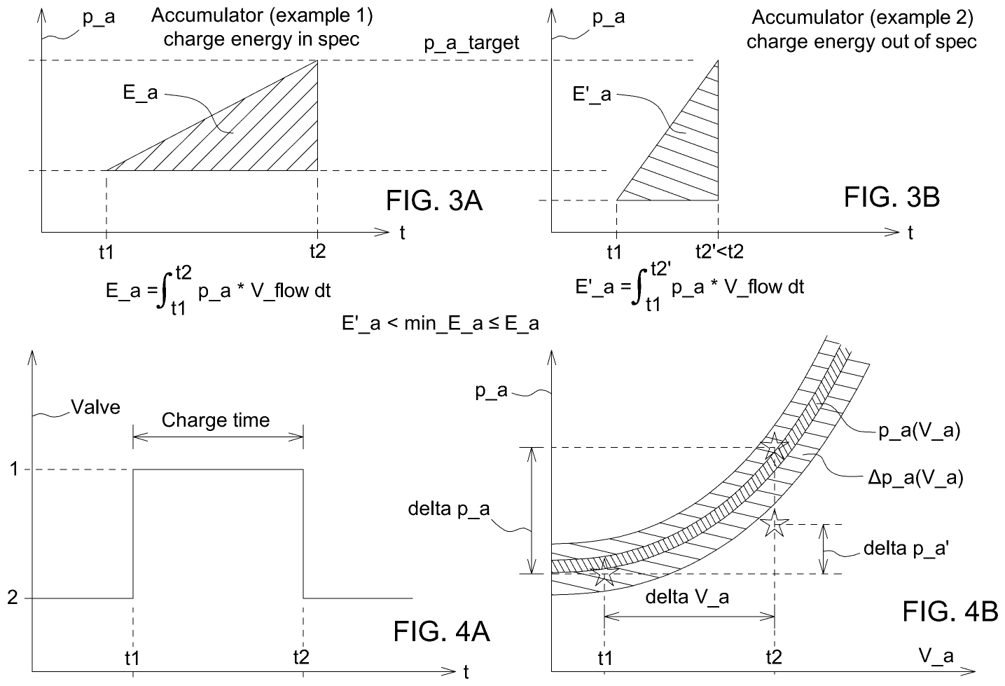

with time integration being carried out over the fill time interval [t1, t2]. This is illustrated in FIG. 3a or 3b for the event that the minimum charge energy min_E has been reached or has not been reached, the shaded area representing the charge energy E_a or E′_a used during the filling of the hydraulic accumulator 14 in each case.

### (ii) Maintaining the Charge Curve

A second approach provides that, at a prompt from the control unit 58, the hydraulic accumulator 14 is filled with pressurized hydraulic fluid from the pivotable pump 20 by opening the 2/2-way valve for a specified fill time interval [t1, t2] (corresponding to FIG. 4a), a resultant pressure difference delta p_a in the fluid chamber 32 relative to a supplied charge volume delta V_a being recorded and checked by the control unit 58 for conformity with a specified charge pressure curve p_a(V_a) for in-spec operation of the hydraulic accumulator 14 in order to conclude a malfunction of the hydraulic accumulator 14 in the event of a lack of conformity. The latter is illustrated in FIG. 4b by the differing value pair (delta p_a′, delta_V_a).

Therefore, the control unit 58 carries out an evaluation as to whether the ascertained value pair (delta p_a, delta V_a) can be placed accordingly within a permissible tolerance range Δ p_a(V_a) along the specified charge pressure curve p_a(V_a) (see FIG. 4b). If this is the case, it is to be assumed that the hydraulic accumulator 14 is functioning properly. The supplied charging volume delta V_a derives from the duration of the filling time t2-t1 for a charging-volume flow V_flow which is assumed to be known and is assumed to be constant at a given operating temperature of the hydraulic fluid.

The specified minimum charge energy min_E_a or the specified charge pressure curve p_a(V_a) is different depending on the hydraulic accumulator 14 used and is ultimately determined by the respective specifications of the manufacturer.

As a result, each of the two approaches (i) and (ii) enables a degradation of the energy storage capacity of the hydraulic accumulator 14 to be detected promptly and reliably in different ways.

It is provided that the control unit 58 prevents the start-up of the agricultural tractor 10 in the event of a detected malfunction of the hydraulic accumulator 14 by intervening in the drive management system 70 or, if need be, it permits start-up with a reduced driving speed. This primarily takes into account circumstances in which the hydraulic accumulator 14 serves for the redundant backup of the hydraulic supply for critical hydraulic functions, such as functions of the hydraulic brake system 48 and/or hydrostatic vehicle steering 50.

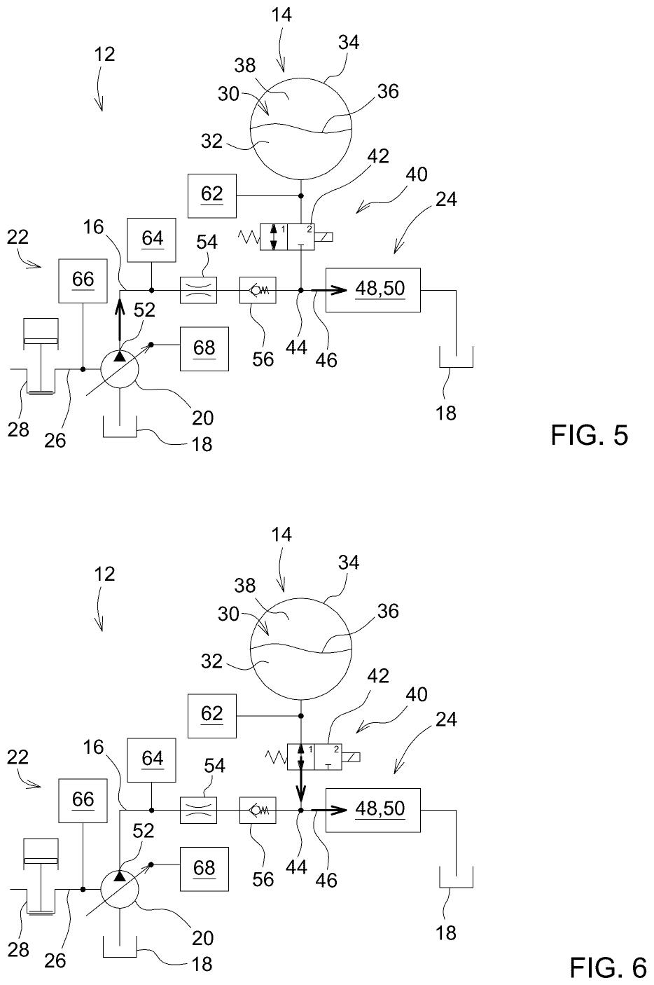

With the completion of the charging procedure, the hydraulic fluid supplied to the hydraulic accumulator 14 may be enclosed in the fluid chamber 32 as a result of closing the 2/2-way valve 42. According to FIG. 5, the hydraulic supply of the hydraulic brake system 48 and/or hydrostatic vehicle steering 50 then takes place exclusively via the pivotable pump 20, according to some embodiments.

In addition, in this operating state, the hydraulic pressure of the stored hydraulic fluid is monitored by the control unit 58 with regard to maintaining a specified minimum system pressure min_p_a, in order to set the agricultural tractor 10 to emergency operating mode in the event that the specified minimum system pressure min_p_a is not reached. The emergency operating mode which is implemented as a result of a corresponding intervention in the drive management system 70 provides for either the driving speed of the agricultural tractor 10 to be limited for the purpose of realizing a slow speed, which enables a safe journey back to a depot or to a workshop, or it provides for a complete vehicle stop. In the present case, the hydraulic pressure of the stored hydraulic fluid is identical to the sensor-recorded charge pressure p_a.

In the event of a detected functional impairment or failure of the primary hydraulic supply of the agricultural tractor 10, which is produced by the pivotable pump 20, the stored hydraulic fluid is used to operate the hydraulic brake system 48 and/or hydrostatic vehicle steering 50 by opening the 2/2-way valve 42 (see FIG. 6). In this case, the stored hydraulic energy is gradually released. An undesired return flow of hydraulic fluid in the direction of the defective pivotable pump 20 is prevented by means of the non-return valve 56. In this way, the maneuverability of the agricultural tractor 10 is maintained, at least for a certain time period, so that the driver has the option of bringing it safely to a standstill at a suitable point.

In addition, upon detection of a malfunction of the hydraulic accumulator 14 and in the event of a functional impairment or failure of the primary hydraulic supply of the agricultural tractor 10, which is produced by the pivotable pump 20, the output of suitable driver information takes place via the user interface 72, which is in communication with the control unit 58, or via the display 74 comprised by the user interface. This also applies in the event that the emergency operating mode is triggered.

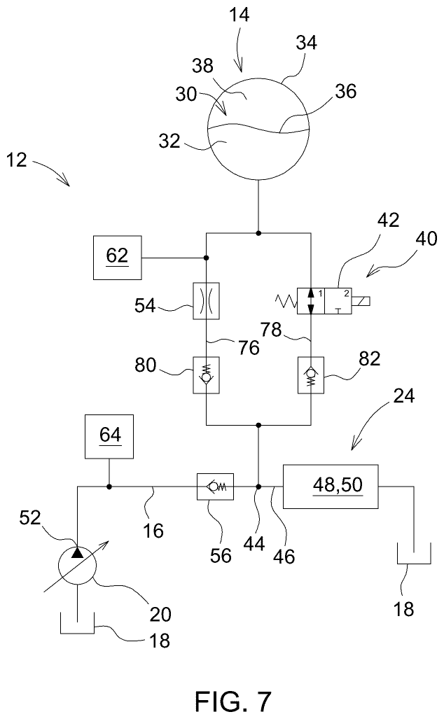

A modification to the arrangement 12 for carrying out the method according to the disclosure is illustrated in FIG. 7. This embodiment differs from that in FIG. 1 in terms of the position of the hydraulic diaphragm 54, which is located here in a separate charging line 76, which extends from the T-junction 44 in the direction of the hydraulic accumulator 14. In addition to the 2/2-way valve 42 arranged in a discharge line 78, two further non-return valves 80, 82 are provided, which ensure that a hydraulic flow during the filling or discharging of the hydraulic accumulator 14 is limited exclusively to the line 76, 78 provided for this purpose, according to some embodiments.

For the sake of completeness, it should be noted that the method according to the disclosure is suitable for checking the state of any desired hydraulic accumulator 14; this does not necessarily have to be part of a hydraulic system in a vehicle. The illustration of an agricultural tractor 10 is also intended to be merely representative of agricultural and forestry vehicles of any type (i.e., work vehicles). This may also relate to a construction vehicle or to a stationary application.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for checking the state of a hydraulic accumulator having a fluid chamber during a charging procedure of the hydraulic accumulator when prompted by a control unit, comprising:
filling the fluid chamber with pressurized hydraulic fluid including one or more of the following:
(i) until a specified target charge pressure is reached, the charge energy used during filling being calculated by the control unit through time integration of the product of the sensor-recorded charge pressure and the charge volume flow and compared to a specified minimum charge energy in order to conclude a malfunction of the hydraulic accumulator if the specified minimum charge energy is not reached; and
(ii) for a specified fill time interval, a resultant pressure difference delta in the fluid chamber relative to a supplied charge volume delta being recorded and checked by the control unit for conformity with a specified charge pressure curve for in-spec operation of the hydraulic accumulator in order to conclude a malfunction of the hydraulic accumulator in the event of a lack of conformity.

2. The method of claim 1, wherein the pressurized hydraulic fluid is generated by a pivotable pump fed from a hydraulic reservoir.

3. The method of claim 2, wherein the charge volume flow is calculated by the control unit, starting with a sensor-recorded pump speed subject to a displacement volume flow of the pivotable pump per revolution resulting from a sensor-recorded pivot angle.

4. The method of claim 1, wherein the charge volume flow is calculated by the control unit subject to a sensor-recorded pressure decrease, which occurs at a hydraulic diaphragm through which the pressurized hydraulic fluid flows during the filling of the fluid chamber.

5. The method of claim 1, wherein the hydraulic accumulator is comprised by a hydraulic system of a work vehicle, the control unit preventing the start-up of the work vehicle in the event of a detected malfunction of the hydraulic accumulator by intervening in a drive management system or permitting start-up with a reduced driving speed.

6. The method of claim 1, wherein, with the completion of the charging procedure, the hydraulic fluid supplied to the hydraulic accumulator is stored in the fluid chamber as a result of closing a valve.

7. The method of claim 6, wherein the hydraulic accumulator is part of a hydraulic system of a work vehicle, the hydraulic pressure of the stored hydraulic fluid being monitored by the control unit with regard to maintaining a specified minimum system pressure in order to set the work vehicle to emergency operating mode if the specified minimum system pressure is not reached.

8. The method of claim 6, wherein, in the event of a detected functional impairment or failure of a primary hydraulic supply, the stored hydraulic fluid is used to operate one or more of a hydraulic brake system and a hydrostatic vehicle steering of a work vehicle, by opening the valve.

9. A system for checking the state of a hydraulic accumulator having a fluid chamber during a charging procedure of the hydraulic accumulator, comprising:
a control unit configured to perform one or more of the following:
(i) calculate a charge energy used during filling of the fluid chamber until a specified target charge pressure is reached through time integration of the product of the sensor-recorded charge pressure and the charge volume flow and compared to a specified minimum charge energy in order to conclude a malfunction of the hydraulic accumulator if the specified minimum charge energy is not reached; and
(ii) record and check a resultant pressure difference delta in the fluid chamber relative to a supplied charge volume delta for a specified fill time interval for conformity with a specified charge pressure curve for in-spec operation of the hydraulic accumulator in order to conclude a malfunction of the hydraulic accumulator in the event of a lack of conformity.

10. The system of claim 9, wherein the pressurized hydraulic fluid is generated by a pivotable pump fed from a hydraulic reservoir.

11. The system of claim 10, wherein the charge volume flow is calculated by the control unit, starting with a sensor-recorded pump speed subject to a displacement volume flow of the pivotable pump per revolution resulting from a sensor-recorded pivot angle.

12. The system of claim 9, wherein the charge volume flow is calculated by the control unit subject to a sensor-recorded pressure decrease, which occurs at a hydraulic diaphragm through which the pressurized hydraulic fluid flows during the filling of the fluid chamber.

13. The system of claim 9, wherein the hydraulic accumulator is comprised by a hydraulic system of a work vehicle, the control unit preventing the start-up of the work vehicle in the event of a detected malfunction of the hydraulic accumulator by intervening in a drive management system or permitting start-up with a reduced driving speed.

14. The system of claim 9, wherein, with the completion of the charging procedure, the hydraulic fluid supplied to the hydraulic accumulator is stored in the fluid chamber as a result of closing a valve.

15. The system of claim 14, wherein the hydraulic accumulator is part of a hydraulic system of a work vehicle, the hydraulic pressure of the stored hydraulic fluid being monitored by the control unit with regard to maintaining a specified minimum system pressure in order to set the work vehicle to emergency operating mode if the specified minimum system pressure is not reached.

16. The system of claim 14, wherein, in the event of a detected functional impairment or failure of a primary hydraulic supply, the stored hydraulic fluid is used to operate one or more of a hydraulic brake system and a hydrostatic vehicle steering of a work vehicle, by opening the valve.
